(19) United States
(12) Patent Application Publication
(10) Pub. No.: US 2012/0002780 A1
(43) Pub. Date: Jan. 5, 2012

(54) METHOD AND APPARATUS FOR BREATHING ADAPTED IMAGING

(75) Inventors: Peter Forthmann, Sandesneben (DE); Holger Schmitt, Hamburg (DE); Udo Van Stevendaal, Ahrensburg (DE); Roland Proska, Hamburg (DE)

(73) Assignee: KONINKLIJKE PHILIPS ELECTRONICS N.V., Eindhoven (NL)

(21) Appl. No.: 13/203,994

(22) PCT Filed: Feb. 9, 2010
(86) PCT No.: PCT/IB10/50585

§ 371 Date: Aug. 31, 2011

Related U.S. Application Data
(60) Provisional application No. 61/163,064, filed on Mar. 25, 2009.

(51) Int. Cl. H05G 1/60; G06K 9/00

(52) U.S. Cl. 378/4; 382/128

(57) ABSTRACT

A method is provided for imaging a portion of a patient that moves as a patient breathes. A motion map is produced of the portion's motion during a breathing cycle of the patient. A scanning protocol is generated using information obtained from the motion map for a given source/detector position and a given point in the breathing cycle. The scanning protocol comprises at least one setting for at least one imaging apparatus component such that a desired amount of x-ray dosage is applied to the portion of the patient at the given source/detector position and the given point in the breathing cycle. An imaging scan is performed of the portion of the patient. The at least one imaging apparatus component is adjusted during the imaging scan.

### DESCRIPTION

The present application relates generally to the imaging arts and more particularly to a method and apparatus for computed tomography (CT) based imaging. It has particular application in CT imaging where a living subject breathes during the acquisition interval, and will be described with particular reference to x-ray CT imaging. However, it may also find more general application in other kinds of imaging, especially wherever a moving object is being imaged, and in other arts.

With the increasing use of x-ray CT imaging in clinical practice, it is desirable to reduce the overall amount of x-ray exposure to the patient during an x-ray CT scan. However, the amount of x-ray dose applied to the patient must be sufficiently high to produce a CT image of acceptable quality.

According to one aspect of the present invention, a method is provided for real time control of the amount of x-ray dose applied to the patient based on the breathing of the patient during the acquisition interval. During a normal breathing cycle, the organs of the chest and abdomen will move. For example, the liver may rise and fall by a few centimeters. The method accounts for this movement of the organs and varies the amount of x-ray dose applied to those organs. While the method finds particular use in connection with CT imaging of a breathing patient, it more generally finds application wherever a moving object is being imaged. It may also find application in other kinds of imaging, different from CT.

According to another aspect of the present invention, a method is provided for imaging a portion of a patient that moves as the patient breathes. A motion map may be produced of the portion's motion during at least part of a breathing cycle of the patient. An image scanning protocol may be generated using the motion map. The scanning protocol may provide at least one setting of at least one imaging apparatus component at a source/detector position and a point in the breathing cycle. An imaging scan may be performed of the portion of the patient. At least one setting of the at least one imaging apparatus component may be adjusted during the imaging scan according to the image scanning protocol.

According to another aspect of the present invention, an imaging system is provided for imaging a portion of a patient that moves as a patient breathes. The system may comprise a data acquisition system, a reconstructor, an image processor, and a controller. The data acquisition system may comprise a radiation source, a radiation sensitive detector, and a collimator. The detector may detect radiation emitted by the source that has traversed an examination region. The collimator may control at least a portion of the radiation emitted by the source. The reconstructor may reconstruct projection data generated by the data acquisition system to generate volumetric data indicative of the portion of the patient. The image processor may process the volumetric data for display on a user interface. The reconstructor or processor may comprise a scanning protocol obtained using a motion map. The scanning protocol may comprise at least one setting of at least one system component at a source/detector position and a point in the breathing cycle. The controller may control the data acquisition system. The controller may cause at least one system component to be adjusted to the at least one setting of the scanning protocol at the source/detector position and the point in the breathing cycle.

One advantage resides in varying the x-ray dose applied to specific organs over the acquisition interval so as to reduce the overall x-ray dose applied to the patient. Numerous additional advantages and benefits will become apparent to those of ordinary skill in the art upon reading the following detailed description of preferred embodiments.

The invention may take form in various components and arrangements of components, and in various process operations and arrangements of process operations.

The drawings are only for the purpose of illustrating preferred embodiments and are not to be construed as limiting the invention.

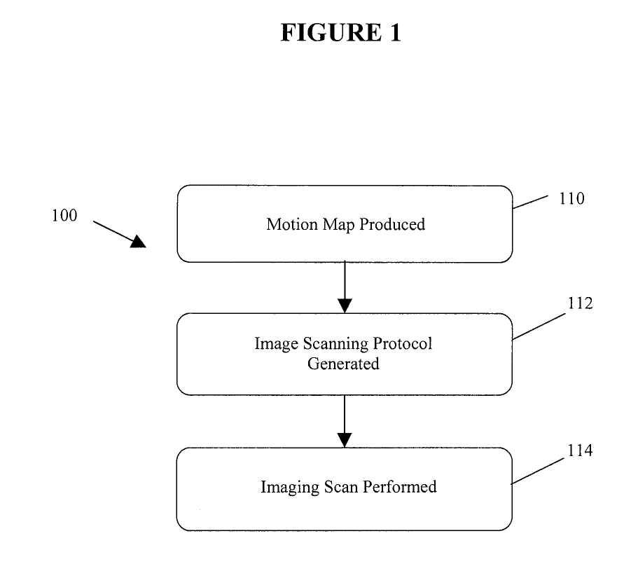

FIG. 1 illustrates an exemplary process for controlling the amount of x-ray dose applied to an imaged organ to account for the organ's movement as a patient breathes during the acquisition interval;

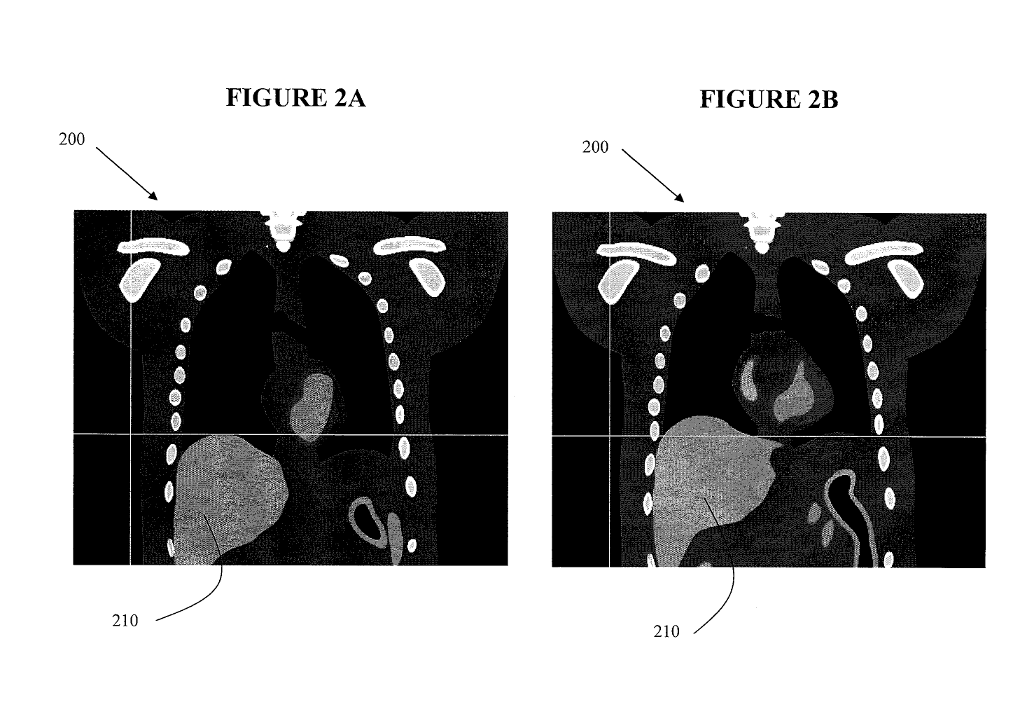

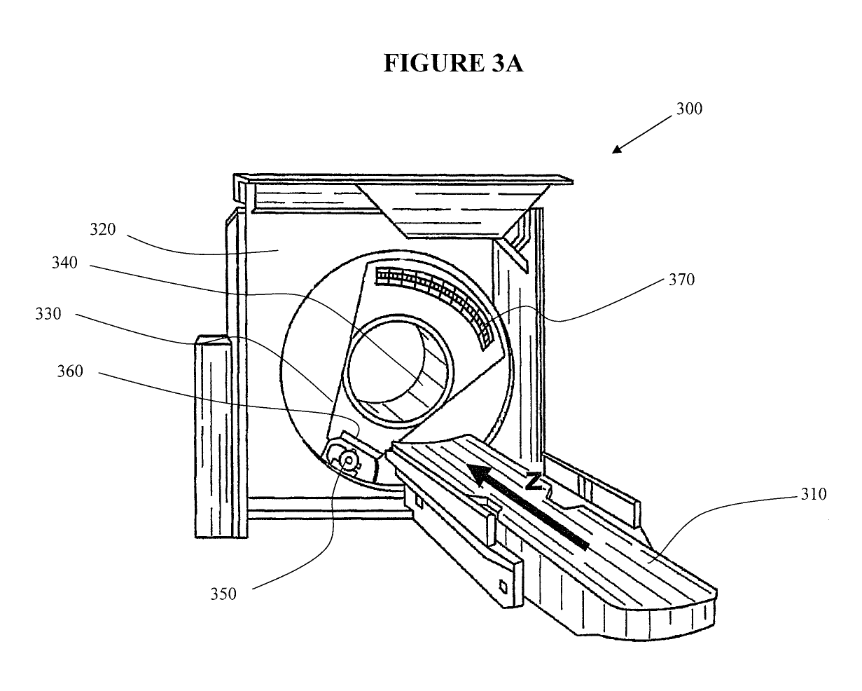

FIGS. 2A and 2B illustrate an anthropomorphic NCAT phantom at two distinct points in a breathing cycle of a human patient;

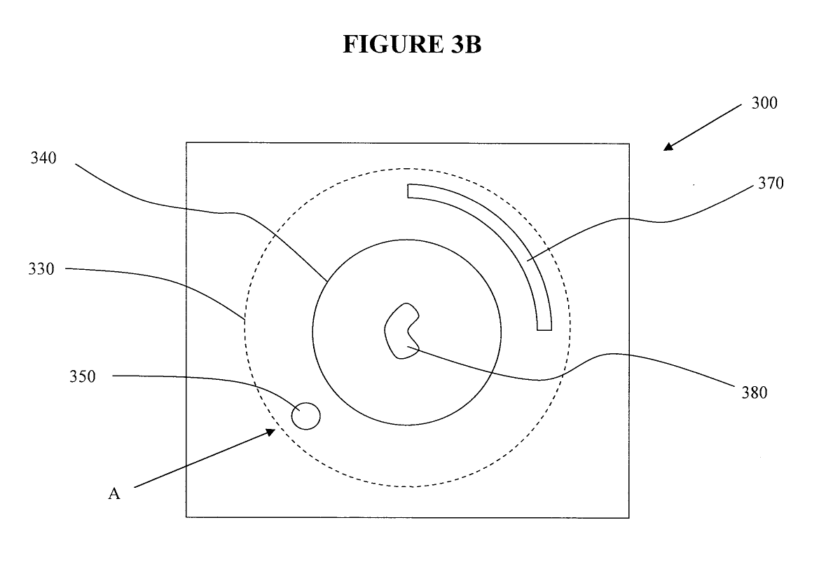

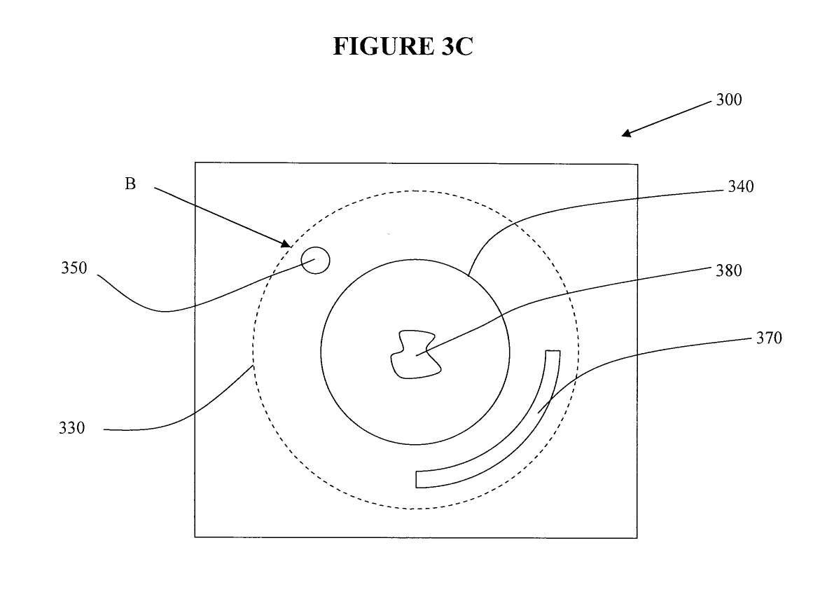

FIG. 3A illustrates an exemplary imaging apparatus suitable for use with the exemplary process of FIG. 1;

FIGS. 3B and 3C schematically illustrate the exemplary imaging apparatus of FIG. 3A with the source and detector at various positions; and

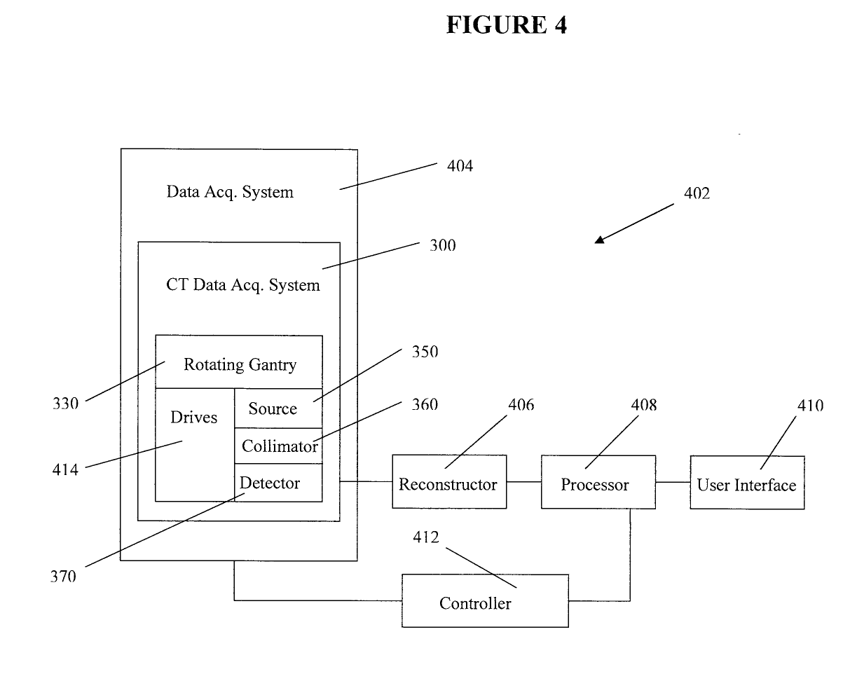

FIG. 4 illustrates an exemplary imaging system suitable for use with the exemplary process of FIG. 1 and the exemplary imaging apparatus of FIG. 3A.

The method and apparatus described here are directed generally to any CT-based imaging process that involves free breathing during the acquisition interval. An exemplary such process 100 is illustrated in FIG. 1. In the representative example, the organs being imaged by a CT imaging apparatus principally include any one or more of the internal organs of the chest and abdomen that move during the breathing cycle, such as the lungs, liver, kidneys, spleen, pancreas, stomach, and the like. In other applications where a moving object is being imaged, other organs might be imaged such as for example the heart, brain, bones, and the like. The illustrative process 100 can be adapted to suit such applications.

The exemplary process 100 of FIG. 1 controls the amount of x-ray dose applied to an imaged organ (and therefore the patient) to account for the organ's movement as the patient breathes during the acquisition interval. In step 110 of the exemplary process 100, a motion map or model is produced of the organ's motion during the breathing cycle. The motion map may be produced using a variety of methods. In one such method, a helical low dose scan of the organ may be performed that contains sufficient data to estimate the organ's motion over time. This method may employ gated reconstruction. The amount of dosage emitted during the helical scan may vary. For example, in one exemplary embodiment, the dosage emitted during an initial helical low dose scan is about 5% of the dosage emitted during a subsequent imaging scan. In a second such method, two dimensional (2D) low dose scans may be performed at multiple points during the breathing cycle. The amount of dosage emitted during the 2D scans may vary. For example, in one exemplary embodiment, the dosage emitted during a 2D low dose scan is about 1% to 3% of the dosage emitted during the main imaging scan. Data from the multiple 2D scans may then be interpolated to produce a motion map of the organ's motion during the breathing cycle. For example, a first 2D scan may be taken at full inhale, with a second 2D scan taken at full exhale, and then a motion map generated by interpolating between them. More than one breathing cycle may be measured during a survey scan and then averaged to provide an estimate of the organ's motion during a breathing cycle of the patient.

A third method for generating a motion map relies solely on modeling data to generate a motion map, without using any actual imaging data of the particular patient being imaged. The model data provides the imaged organ's expected motion during the breathing cycle. Actual patient data such as for example sex, age, height, weight, and/or other patient specific measurements are used with the software model to simulate the organ's motion. In addition, there may be suitable alternative means of generating a motion map not described herein.

Any one or more of these methods may be used, individually or in combination, to produce the motion map. For example, actual image data regarding the particular patient may be used in conjunction with modeling data to increase the accuracy of a motion map generated using the modeling data. One software model that may be used is the four dimensional NURBS-based cardiac-torso (NCAT) phantom 200. FIGS. 2A and 2B show an anthropomorphic NCAT phantom 200 at two distinct points in the breathing cycle. Movement of one or more organs of the patient during the breathing cycle is shown by comparing the two NCAT phantoms 200. For example, FIG. 2A shows the phantom 200 at a first point in the breathing cycle with the liver 210 in a first position and configuration. FIG. 2B shows the phantom 200 at a second point in the breathing cycle with the liver 210 in a second position and configuration. As shown from the comparison of FIGS. 2A and 2B, the liver 210 rises and falls during the breathing cycle of the patient.

In one embodiment, the patient may be fitted with a device that tracks his or her breathing cycle during a motion map scan. The information obtained from the breathing cycle tracking device may be correlated with the motion map scan data to estimate the organ's movement at various points in the patient's breathing cycle. Various tracking devices may be used. One exemplary tracking device is an elastic breathing belt fitted about the patient's chest or abdomen. To track the patient's breathing cycle, the belt may comprise sensors that measure the amount of stretch, or resistance to stretching, of the belt as the patient's chest or abdomen expands and retracts. Another exemplary tracking device are external markers attached to the patient's chest or abdomen. The movement of the markers may be tracked as the patient's chest or abdomen expands and retracts during the breathing cycle. For example, in one embodiment, active optical markers are used as a breathing cycle tracking device. The active optical markers emit light which is focused on a stationary screen positioned perpendicular to the z-axis. In another embodiment, radiopaque markers are used as a breathing cycle tracking device. Other similar devices may be used that track the breathing cycle of the patient during the motion map scan.

The motion map produced in step 110 provides an estimate of the movement of the organ at various points during the breathing cycle. With this information, the amount of x-ray dosage applied to the organ may be adjusted in real time to account for the organ's movement during the breathing cycle. At step 112 of the exemplary process 100, an image scanning protocol is generated using information obtained from the motion map. The image scanning protocol specifies, for a given x-ray source/detector position in the CT imaging apparatus and a given point in the breathing cycle, the optimal settings of the CT imaging apparatus to produce an image of acceptable quality while at the same time reducing the overall x-ray dosage applied to the patient. Other information, in addition to the motion map, may be used to generate the image scanning protocol. For example, various properties of the organ such as the organ's density, or the organ's size, shape, and position at a particular point in the breathing cycle, may be used. The settings of many different components in a typical CT imaging apparatus may be changed to vary the amount of x-ray dosage applied to the patient.

In one exemplary configuration, the scanning protocol comprises changing the settings of a dynamic collimator in the CT imaging apparatus, disposed in between the x-ray source and the patient. A collimator is a device that filters the stream of x-rays so that only the x-rays traveling parallel to a specified direction are allowed through. A dynamic collimator may be adjusted to vary the strength and direction of the x-ray beam being applied to the patient. For example, the collimator may have leaves, or jaws, that open and close quickly to permit or block the passage of the x-rays. The amount of x-rays filtered, or absorbed, by the collimator determines the amount of x-ray dosage applied to the patient.

In another exemplary configuration, the scanning protocol comprises changing the x-ray source itself to vary the amount of x-ray dosage applied to the patient. For example, reducing the current applied to the x-ray source reduces the amount of x-rays generated, and increasing the current increases the amount of x-rays generated. Or, the duration of the x-rays emitted by the x-ray source may be controlled to vary the amount of x-ray dosage applied.

Thus, by changing the settings of components in the CT imaging apparatus (such as a dynamic collimator and the x-ray source), the amount of x-ray dosage applied to the patient may be varied during an imaging scan. For a particular x-ray source/detector position, the motion map will provide a rough estimate of the expected position and contours of the organ or organs being imaged. Based on that estimate, and a priori knowledge concerning the estimated density of the various regions being traversed by the x-rays in the imaged object including the organ or organs being imaged, an optimal x-ray dosage may be calculated. The settings of the CT apparatus components may then be adjusted to provide that optimal x-ray dosage. This process may be repeated for multiple x-ray source/detector positions about the examination region and for multiple points in the patient's breathing cycle. The collection of such settings, based on x-ray source/detector position and breathing cycle point, makes up an image scanning protocol.

In step 114 of the exemplary process 100, the CT imaging apparatus performs an imaging scan to produce a CT image of the organ. During the imaging scan, one or more of the CT imaging apparatus components is adjusted, according to the scanning protocol. The scanning protocol provides the optimal CT imaging apparatus component settings for a given x-ray source/detector position and a given point in the patient's breathing cycle.

To implement the scanning protocol during the imaging scan, a breathing cycle tracking device may be used to provide information to the CT imaging apparatus regarding the current state of the patient's breathing at any point during the scan. Any one or more of the breathing cycle tracking devices already described herein, or any other appropriate tracking device, may be used for that purpose. Using the breathing cycle information received from the tracking device, and the current x-ray source/detector position, the CT imaging apparatus can obtain the optimal setting configuration from the image scanning protocol. It can then modify the corresponding components of the CT imaging apparatus accordingly during an imaging scan.

As stated, the exemplary process 100 is directed generally to any CT-based imaging process that involves free breathing during the acquisition interval. Such scans may involve, for example, patients that may be unable to hold their breath during the scan such as young children, older patients, mentally unstable patients, or patients with breathing disorders. Further, the exemplary process 100 may be used with a multimodal imaging device, such as a positron emission tomography/computed tomography (PET/CT) system or a single photon emission computed tomography/computed tomography (SPECT/CT) system. Acquisition of a PET scan may take as long as 20 minutes. As such, the patient is not able to hold his or her breath during the PET scan. The motion effects due to the patient's breathing may be accounted for when the PET and CT images are combined into a single superposed, or co-registered, image.

FIG. 3A illustrates an exemplary imaging apparatus 300 of the present application suitable for use with the exemplary CT imaging process 100 and generally any medical imaging system, for example, a CT, SPECT or PET imaging system. The imaging apparatus 300 includes a subject support 310, such as a table or couch, which supports and positions a subject being examined and/or imaged, such as a patient. The imaging apparatus 300 includes a stationary gantry 320 with a rotating gantry 330 mounted inside. A scanning tube 340 extends through the stationary gantry 320. The scanning tube 340 defines an examination region. The subject support 310 is linearly movable along a Z-axis relative to the scanning tube 340, thus allowing the subject support and the imaged subject when placed thereon to be moved within and removed from the scanning tube 340.

The rotating gantry 330 is adapted to rotate around the scanning tube 340 (i.e., around the Z-axis) and the imaged subject when located therein. One or more x-ray sources 350 with collimator(s) 360 are mounted on the rotating gantry 330 to produce an x-ray beam directed through the scanning tube 340 and the imaged subject when located therein. One or more radiation detector units 370 are also mounted on the rotating gantry 330. Typically, the x-ray source(s) 350 and the radiation detector unit(s) 370 are mounted on opposite sides of the rotating gantry 330 from one another and the rotating gantry is rotated to obtain an angular range of projection views of the imaged subject.

FIG. 3B schematically illustrates the imaging apparatus 300 with the rotating gantry 330 rotated such that the x-ray source 350 and the x-ray detector 370 are in a first position A. Further, a breathing cycle tracking device (not shown) provides information to the imaging system regarding the state of the patient's breathing with the source 350 and the detector 370 in the first position A. The imaging system references the image scanning protocol generated using information obtained from the motion map to retrieve the optimal settings for the imaging apparatus 300 components, such as the source 350 and the collimator 360. As discussed, the optimal settings may at least be based on the current position of the source 350 and the detector 370, the current state of the patient's breathing, and a priori knowledge concerning the estimated density of the various regions being traversed by the x-rays in the imaged object including the organ 380 being imaged. These optimal settings of the imaging apparatus 300 components produce an image of acceptable quality while at the same time reducing the overall x-ray dosage applied to the patient. The settings of the imaging apparatus 300 components are adjusted throughout an imaging scan to provide the optimal x-ray dosage and to produce an image of the organ 380.

Thus, as the imaging scan proceeds, FIG. 3C schematically illustrates the imaging apparatus 300 with the rotating gantry 330 rotated such that the source 350 and the detector 370 are in a second position B. The breathing cycle tracking device provides information to the imaging system regarding the state of the patient's breathing with the source 350 and the detector 370 in the second position B. The imaging system references the image scanning protocol to retrieve the optimal settings for the imaging apparatus 300 components with the source 350 and the detector 370 in the second position B and the given state of the patient's breathing. The settings of the imaging apparatus 300 components are adjusted to provide the optimal x-ray dosage.

FIG. 4 schematically depicts an exemplary imaging system 402 suitable for use with the exemplary CT imaging process 100 and the exemplary imaging apparatus 300. The imaging system 402 is capable of controlling the amount of x-ray dose applied to an imaged organ (and therefore the patient) while accounting for the organ's movement as the patient breathes during the acquisition interval. The system 402 includes a data acquisition system 404, a reconstructor 406, processor 408, a user interface 410, and a controller 412.

The data acquisition system 404 includes a CT data acquisition system 300 in which the x-ray source 350, collimator 360, and detector 370 are mounted to a rotating gantry 330 for rotation about the examination region. Circular, 360 degrees or other angular sampling ranges as well as axial, helical, circle and line, saddle, or other desired scanning trajectories may be implemented.

In one implementation, the source 350, collimator 360, and detector 370 are fixedly mounted in relation to the rotating gantry 330 so that the acquisition geometry is fixed. In another implementation, the source 350, collimator 360, and detector 370 are movably mounted to the rotating gantry 330 so that the acquisition geometry is variable. In the latter implementation, one or more drives 414 may provide the requisite motive force to move the components. Alternately, the source 350, collimator 360, and detector 370 may be moved manually by a human user.

A reconstructor 406 reconstructs the data generated by the data acquisition system 404 using reconstruction techniques to generate volumetric data indicative of the object under examination. Reconstruction techniques include analytical techniques such as filtered backprojection, as well as iterative techniques.

An image processor 408 processes the volumetric data as required, for example for display in a desired fashion on a user interface 410, which may include one or more output devices such as a monitor and printer and one or more input devices such as a keyboard and mouse.

The user interface 410, which is advantageously implemented using software instructions executed by a general purpose or other computer so as to provide a graphical user interface (“GUI”), allows the user to control or otherwise interact with the imaging system 402. For example, the user may select one or more of a desired motion map; initiate and terminate scans; select desired scan or reconstruction protocols; manipulate the volumetric data; and the like. In one implementation, one or more of the source 350 configuration, collimator 360 configuration, and reconstruction protocol are established automatically by the imaging system 402 based on a scan protocol and/or motion map selected by the user. As yet another example, the user interface 410 may prompt or otherwise allow the user to enter or modify one or more of a desired motion map, source 350 configuration, and collimator 360 configuration. In such an implementation, the information from the user is used to automatically calculate the requisite settings of the source 350 and collimator 360.

A controller 412 operatively connected to the processor 408 controls the operation of the data acquisition system 404. For example, the controller may carry out a desired motion map scan or imaging scan, cause the drive(s) 414 to position the source 350, collimator 360, and/or detector 370, or cause the drive(s) 414 to adjust the leaves of the collimator 360.

Thus the aforementioned functions can be performed as software logic. “Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

The systems and methods described herein can be implemented on a variety of platforms including, for example, networked control systems and stand-alone control systems. Additionally, the logic shown and described herein preferably resides in or on a computer readable medium such as the memory in processor 408 or controller 412. Examples of different computer readable media include Flash Memory, Read-Only Memory (ROM), Random-Access Memory (RAM), programmable read-only memory (PROM), electrically programmable read-only memory (EPROM), electrically erasable programmable read-only memory (EEPROM), magnetic disk or tape, optically readable mediums including CD-ROM and DVD-ROM, and others. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof. The invention may take form in various components and arrangements of components, and in various steps and arrangements of steps. The drawings are only for purposes of illustrating the preferred embodiments and are not to be construed as limiting the invention.

1. A method of imaging a portion of a patient that moves as the patient breathes, the method comprising:
producing a motion map of the portion's motion during at least part of a breathing cycle of the patient;
generating an image scanning protocol using the motion map, wherein the scanning protocol provides at least one setting of at least one imaging apparatus component at a source/detector position and a point in the breathing cycle; and
performing an imaging scan of the portion of the patient, wherein at least one setting of the at least one imaging apparatus component is adjusted according to the image scanning protocol.

2. The method of claim 1, wherein the generating and performing steps are performed for multiple source/detector positions and multiple points in the breathing cycle.

3. The method of claim 1, wherein the portion of the patient comprises at least one internal organ of the patient's chest or abdomen.

4. The method of claim 1, wherein the motion map is at least partially produced using a helical low dose scan.

5. The method of claim 4, wherein a radiation dosage emitted during the helical low dose scan is about 5% of a radiation dosage emitted during the imaging scan.

6. The method of claim 1, wherein the motion map is at least partially produced using a two dimensional low dose scan.

7. The method of claim 6, wherein a radiation dosage emitted during the two dimensional low dose scan is about 1% to 3% of a radiation dosage emitted during the imaging scan.

8. The method of claim 1, wherein the motion map is at least partially produced using a model that simulates the portion's motion during the breathing cycle of the patient.

9. The method of claim 1, wherein the motion map is at least partially produced from an initial scan of the portion of the patient using a device that tracks the patient's breathing cycle during the initial scan to produce the motion map.

10. The method of claim 1, wherein a desired amount of x-ray dosage is at least partially calculated using the motion map.

11. The method of claim 1, wherein a breathing cycle tracking device tracks the breathing cycle of the patient during the imaging scan.

12. The method of claim 1, wherein the motion map is produced solely using data generated from an initial scan of the patient.

13. The method of claim 1, wherein the motion map is produced using data generated from an initial scan of the patient and modeling data.

14. The method of claim 1, wherein the motion map is produced solely using modeling data.

15. A method of imaging an internal organ of a patient that moves as the patient breathes, the method comprising:
producing a motion map of the organ's motion during at least part of a breathing cycle of the patient, wherein the motion map is at least partially produced using an initial scan of the organ of the patient;
generating a scanning protocol using the motion map, wherein the scanning protocol provides at least one setting of a collimator at a source/detector position and a point in the breathing cycle; and
performing an imaging scan of the organ of the patient, wherein a breathing cycle tracking device tracks the breathing cycle of the patient during the initial scan and the imaging scan.

16. A CT imaging system for imaging a portion of a patient that moves as a patient breathes, the system comprising:
a data acquisition system having
a radiation source,
a radiation sensitive detector which detects radiation emitted by the source that has traversed an examination region, and
a collimator which controls at least a portion of the radiation emitted by the source;
a reconstructor to reconstruct a projection data generated by the data acquisition system to generate volumetric data indicative of the portion of the patient;
an image processor that processes the volumetric data for display on a user interface, wherein the processor comprises a scanning protocol obtained using a motion map, and wherein the scanning protocol comprises at least one setting of at least one system component at a source/detector position and a point in the breathing cycle; and
a controller to control the data acquisition system, wherein the controller causes at least one system component to be adjusted to the at least one setting of the scanning protocol at the source/detector position and the point in the breathing cycle.

17. The system of claim 16, wherein the motion map is at least partially produced using a helical low dose scan.

18. The system of claim 16, wherein the motion map is at least partially produced using a two dimensional low dose scan of the portion of the patient.

19. The system of claim 16, wherein the motion map is at least partially produced using a model that simulates the portion's motion during the breathing cycle of the patient.

20. The system of claim 16, wherein the motion map is at least partially produced from an initial scan of the patient using a device that tracks the patient's breathing cycle during the initial scan to produce the motion map.

21. The system of claim 16, wherein a desired amount of x-ray dosage is at least partially calculated using the motion map.

22. The system of claim 16, wherein the motion map is produced solely using data generated from an initial scan of the patient.

23. The system of claim 16, wherein the motion map is produced using data generated from an initial scan of the patient and modeling data.

24. The system of claim 16, wherein the motion map is produced solely using modeling data.
